(19) United States
(12) Patent Application Publication
(10) Pub. No.: US 2023/0033691 A1
(43) Pub. Date: Feb. 2, 2023

(54) PERSONAL CARE DEVICE

(71) Applicant: Braun GmbH, Kronberg (DE)

(72) Inventors: Marvin Thorsten Knorr, Hochheim am Main (DE); Thomas Verstege, Frankfurt am Main (DE); Stefan Fuerst, Eschborn (DE); Martin Fuellgrabe, Bad Camberg (DE); Reinhold Eichhorn, Idstein (DE); Christian Neyer, Eschborn (DE)

(21) Appl. No.: 17/875,498

(22) Filed: Jul. 28, 2022

(30) Foreign Application Priority Data
Jul. 29, 2021 (EP) 21188504.1

(51) Int. Cl. B26B 19/38

(52) U.S. Cl. CPC B26B 19/3886; B26B 19/3853; B26B 19/388; B26B 19/048

(57) ABSTRACT

The present invention relates to a personal care device, in particular hair removal device such as an electric shaver, comprising an elongated handle for manually moving the personal care device along a body surface, a working head attached to said handle for effecting a personal care treatment to said body surface, said working head being movably supported relative to said handle and/or including a working head element being movably supported relative to a working head basis to allow adaption of the working head and/or of the working head element to the body surface contour, wherein an adjustment device is provided for adjusting a movability characteristic of a suspension of said working head and/or of said working head element, wherein said adjustment device includes at least one actuator for adjusting at least one characteristic.

### FIELD OF THE INVENTION

The present invention relates to a personal care device, in particular hair removal device such as an electric shaver, comprising an elongated handle for manually moving the personal care device along a body surface, a working head attached to said handle for effecting a personal care treatment to said body surface, said working head being movably supported relative to said handle and/or including a working head element being movably supported relative to a working head basis to allow adaption of the working head and/or the working head element to the body surface contour, wherein an adjustment device is provided for adjusting a movability characteristic of a suspension of said working head and/or of said working head element.

### BACKGROUND OF THE INVENTION

Personal care devices are widely used to apply different types of personal care treatments to users, wherein such personal care devices may include hair removal devices such as epilators, shavers or razors which may be electric or manual and/or wet or dry, or beard trimmers. Furthermore, other personal care devices include dental care appliances such as electric or manual tooth brushes, interdental cleaners or gum massaging devices, or skin treatment devices such as massaging devices or vibrators. All such personal care devices are subject to the problem that different users use the personal care devices in different ways and different users have different preferences for the mechanical settings of the personal care device.

In a more general context, some users tend to rather strongly press the working head against the body surface to be treated, whereas other users apply rather slight pressure. Some users tend to move the working head over the body surface at rather fast speeds in rather short strokes, whereas other users apply slower speeds and longer strokes. Depending on the user habits and preferences, the working head should provide for a softer or more precise user feeling what is achievable e.g. by different movability characteristics of the suspension allowing for movements of the working head relative to the handle and/or movements of the working head element(s) relative to the working head basis.

Changing the movability characteristics also may be desirable for the same user when using the personal care device in different treatment modes, in different phases of the treatment or at different body portions or different treatment behaviors. For example, when shaving the upper lip region below the nose, short strokes are made and more control is desired so working head stiffness should be increased, whereas shaving the cheeks or the region around the adam's apple may require less stiffness and/or a wider pivoting/swiveling range to achieve better contour adaption.

To allow for contour adaptions, i.e. adaption of a skin contact surface of the working head to the contour of the body portion to be treated, the suspension of the working head relative to the handle and/or the suspension of the working head element relative to a working head basis may allow for various types of movements of the working head and the working head element, respectively, such as rotatory movements and/or linear movements thereof. More particularly, the working head may tilt and/or swivel relative to the elongated handle, wherein a tilt axis and a swivel axis may extend substantially parallel to the skin contact surface of the working head and transverse to each other. In addition or in the alternative, the working head may dive or float relative to the handle along a diving axis substantially perpendicular to the skin contact surface and/or substantially parallel to the longitudinal axis of the handle. Similarly, a working head element such as a shear foil cartridge of a shaver may tilt and/or swivel and/or dive relative to the working head frame or working head basis to allow adaption to the skin contour.

So as to meet different users' habits and preferences, the suspension of the working head and/or the suspension of the working head element relative to the working head basis may be adjusted to change the characteristics of the adjusting movements of the working head and/or the working head element. For example, the tilting and/or swiveling and/or diving stiffness, i.e. the resistance against a force or torque or movement causing the head to tilt, swivel or dive, may be increased or decreased to provide for a more precise (stiffer) or a softer characteristic of the adjustment movements. Furthermore, also the tilting and/or swiveling and/or diving range in terms of the maximum rotatory and/or linear displacement may be varied.

For example, EP 3 546 153 B1 shows an electric shaver having a pivotable suspension of its working head to allow for pivoting of the working head relative to the handle and a diving suspension of the shear foil cartridge to allow for diving of the shear foil cartridge relative to the working head frame. The pivoting stiffness of the working head and the diving stiffness of the shear foil cartridge are controlled by means of mechanical springs which can be adjusted by means of actuators so as to increase and decrease pivoting stiffness and diving stiffness in terms of the torque and force necessary to achieve a certain pivot angle and a certain diving displacement. Moreover, the adjustment mechanism is configured to adjust the angular pivoting range of the working head to allow a larger or smaller maximum angular displacement.

A similar adjustability of the working head of an electric shaver is shown by document EP 3 546 152 B1.

### SUMMARY OF THE INVENTION

It is an objective underlying the present invention to provide for an improved personal care device avoiding at least one of the disadvantages of the prior art and/or further developing the existing solutions. A more particular objective underlying the invention is to provide for an improved self-adjustment of the personal care device to the user and varying use situations.

A further objective underlying the invention is to provide for an improved personal care device quickly achieving adaption to varying body surface contours and treatment regions.

A still further objective underlying the invention is to achieve better self-adjusting to complex interaction of characteristics of treatment situations.

To achieve at least one of the aforementioned objectives, it is suggested to provide for an adjustment actuator for varying the moving resistance of the movable working head and/or of the movable working head element in dependency of the moving speed of the working head and/or the working head element. For clarification, it should be mentioned that the moving speed may be the velocity of the working head element relative to the working head basis in a linear or rotary way or the velocity of the working head relative to the handle of the personal care device in a linear or rotary way. More particularly, the graph defining the relationship between the force and/or torque necessary to move the working head and/or the working head element, and the moving speed can be varied by means of said actuator so as to, for example, increase or decrease the force and/or torque necessary to move the working head and/or the working head element at a certain speed. For example, when the working head is suspended in a tilting and/or swiveling manner, the force and/or torque necessary to tilt and/or swivel the working head at a certain rotatory speed may be increased or decreased to achieve a higher or lower rotatory stiffness, wherein different rotatory stiffnesses may be provided for different rotatory speeds.

More particularly, the adjustment actuator for varying the moving resistance depending on moving speed may be configured to adjust and/or vary the shape of the graph defining moving resistance over moving speed of the working head and/or working head element, wherein for example, the adjustment actuator may be configured to vary the curvature of such graph and/or to vary the shape of such graph from linear to non-linear and/or to vary the ratio of linear portions to non-linear portions and/or to vary the steepness of certain portions.

Such adjustment actuator for varying the moving resistance depending on moving speed may include a viscose type of friction device which may include a fluid pusher to push away a viscose fluid when moving. To adjust the moving resistance, a smart viscose fluid may be used which is configured to change its viscosity when subject to a magnetic field and/or electric field to allow for quick changes of viscosity to allow for adjustments during one round of personal care treatment.

Such viscose friction device may provide for a moving resistance increasing with moving speed.

More particularly, such viscose friction device may include an adjustable damper configured to provide varying damping forces which may add a reacting counter force against the movement of the working head or working head element.

According to another aspect, at least one adjustment actuator may be provided for varying a breaking resistance counteracting and/or braking movement of the working head and/or the working head element irrespective of the direction thereof. Contrary to biasing devices such as preloading springs urging the working head towards a certain position, such braking resistance counteracts and/or brakes the working head and/or working head element moving in either direction. In other words, the direction of the braking force changes with the direction of the movement of the working head and/or working head element to always counteract such movements.

The adjustment actuator may be configured to vary the absolute value of the braking force and/or braking torque. In the alternative or in addition, the adjustment actuator may be configured to vary the shape of a graph of the braking force and/or braking torque counteracting movements of the working head and/or working head element, over displacement. For example, the adjustment device may provide for a linear function of the braking force and/or braking torque verses displacement of the working head and/or working head element and/or may provide for a non-linear function thereof. More particularly, the adjustment device may vary the slope of such linear graph defining the braking force/braking torque over displacement and/or may vary the shape of a graph defining the braking force/braking torque versus displacement of the working head and/or working head element, for example from a linear shape to a non-linear shape. In addition or in the alternative, the adjustment device may vary the ratio of linear portions to non-linear portions.

For example, to allow variation of the braking force and/or braking torque, a mechanical brake such as a disc brake may be connected to the working head and/or the working head element, wherein such braking device may provide for dry friction. To vary the braking force and/or braking torque, an actuator may be provided for varying the contact pressure of the cooperating movable and non-movable braking elements.

According to a still further aspect, at least one adjustment actuator may be provided for varying the shape of a graph defining the restoring force and/or restoring torque of a restoring device over rotatory and/or linear displacement of the working head and/or working head element from a linear shape to a curved shape and/or the ratio of linear portions to non-linear portions of said graph.

More particularly, the restoring device for urging the working head and/or the working head element towards a desired neutral position may include at least one leaf spring connected to the working head and/or the working head element, wherein the adjustment actuator may be configured to change the effective length of such leaf spring.

### BRIEF DESCRIPTION OF THE DRAWINGS

FIG. 1: a front view of a personal care device in terms of an electric shaver including a working head suspended to allow tilting and swiveling of the working head relative to the handle of the personal care device about a tilt axis and a swivel axis,

FIG. 2a-2b: a partial perspective view of the working head of the personal care device of FIG. 1, wherein partial view (a) illustrates the orientation of the swivel axis and the tilt axis of the working head relative to the skin contact surface thereof and partial view (b) illustrates the linear displacement axis of a working head element of the working head in terms of a diving axis allowing for diving of the working head element relative to the working head basis,

FIG. 3a-3b: functional diagrams illustrating, in partial view (a), the functional relationship between swiveling/tilting torque and swiveling/tilt angle of the working head of the personal care device of FIG. 1 and variation of such a function in a relationship, and, in partial view (b), a functional relationship between the diving force and linear displacement of the working head element of the working head element of FIG. 2a-2b, and variation of such a functional relationship, with the relationships being linear or non-linear, drawn as non-linear curves in this figure.

FIG. 4: a linear relationship between swiveling/tilting torque and swiveling/tilting angle and variation of such linear relationship,

FIG. 5: a sectional side view of the personal care device of the preceding figures, illustrating a restoring device for restoring the working head towards a neutral swiveling position, wherein such restoring device includes a leaf spring and the adjustment actuator for adjusting the restoring characteristic is configured to vary the effective length of the leaf spring,

FIG. 6: a function diagram based on FIG. 3a-3b illustrating swiveling/tilting torque versus swiveling/tilting angle of the working head of the personal care device of FIG. 1 and variation thereof by means of an adjustment actuator for adjusting the tilting/swiveling range,

FIG. 7: a sectional side view of the personal care device corresponding to the preceding figure, illustrating the adjustment actuator for adjusting the swiveling range,

FIG. 8a-8b: functional diagrams illustrating, in partial view (a), the functional relationship between swiveling/tilting torque and swiveling/tilting rotatory speed and variation of such functional relationship, and, in partial view (b), the functional relationship between diving force and linear diving velocity and variation thereof as provided by a viscose friction device,

FIG. 9: a functional diagram illustrating the functional relationship between swiveling/tilting torque and swiveling/tilting rotatory speed, and variation thereof, as provided by a dry friction device,

FIG. 10: a partial sectional front view of the personal care device of the preceding figures, illustrating a dry friction device for braking tilting movements of the working head,

FIG. 11: a functional diagram illustrating the functional relationship between swiveling/tilting torque and swiveling/tilting rotatory speed, as provided by a viscose friction device,

FIG. 12: a sectional side view of the personal care device of the preceding figures, illustrating the viscose friction device providing for braking swiveling movements of the working head,

FIG. 13: a functional diagram illustrating a hybrid functional relationship between swiveling/tilting torque and swiveling/tilting rotatory speed of the working head including portions where torque depends on rotatory speed and portions where torque does not depend on rotatory speed.

### DETAILED DESCRIPTION OF THE INVENTION

As becomes apparent from the Figures, it is suggested to provide for an adjustment actuator for varying the moving resistance of the movable working head and/or of the movable working head element in dependency of the moving speed of the working head and/or the working head element relative to the handle or relative to a working head base as regards the working head element. More particularly, the graph defining the relationship between the force and/or torque necessary to move the working head and/or the working head element, and the moving speed can be varied by means of said actuator so as to, for example, increase or decrease the force and/or torque necessary to move the working head and/or the working head element at a certain speed.

For example, when the working head is suspended in a tilting and/or swiveling manner, the force and/or torque necessary to tilt and/or swivel the working head at a certain rotatory speed may be increased or decreased to achieve a higher or lower rotatory stiffness or movement resistance, wherein different rotatory stiffnesses may be provided for different rotatory speeds.

More particularly, the adjustment actuator for varying the moving resistance depending on moving speed may be configured to adjust and/or vary the shape of the graph defining moving resistance over moving speed of the working head and/or working head element, wherein for example, the adjustment actuator may be configured to vary the curvature of such graph and/or to vary the shape of such graph from linear to non-linear and/or to vary the ratio of linear portions to non-linear portions and/or to vary the steepness of certain portions.

For example, said adjustment actuator may be configured to provide for a moving resistance of zero when moving speed is zero and to provide for an amount of moving resistance larger than zero when the working head and/or the working head element is moving, wherein a direction of moving resistance force/torque for negative moving speeds is opposite to a direction of moving resistance force/torque for positive moving speeds. The branches of said graph may be shaped differently and the shape may be changed by said actuator, for example from curved to straight or from slightly curved to strongly curved or from convex to concave, or from only curved to a mixture of curved and straight portions.

Such adjustment actuator for varying the moving resistance depending on moving speed may include a viscose type of friction device which may include a fluid pusher to push away a viscose fluid when moving. To adjust the moving resistance, a smart viscose fluid may be used which is configured to change its viscosity when subject to a magnetic field and/or electric field to allow for quick changes of viscosity to allow for adjustments during one round of personal care treatment.

Such viscose friction device may provide for a moving resistance increasing with moving speed.

More particularly, such viscose friction device may include an adjustable damper configured to provide varying damping forces.

According to another aspect, at least one adjustment actuator may be provided for varying a breaking resistance counteracting and/or braking movement of the working head and/or the working head element irrespective of the direction thereof. Contrary to biasing devices such as preloading springs urging the working head towards a certain position, such braking resistance counteracts and/or brakes the working head and/or working head element moving in either direction. In other words, the direction of the braking force changes with the direction of the movement of the working head and/or working head element to always counteract such movements.

The adjustment actuator may be configured to vary the absolute value of the braking force and/or braking torque. In the alternative or in addition, the adjustment actuator may be configured to vary the shape of a graph of the braking force and/or braking torque counteracting movements of the working head and/or working head element, over displacement. For example, the adjustment device may provide for a linear function of the braking force and/or braking torque versus displacement of the working head and/or working head element and/or may provide for a non-linear function thereof. More particularly, the adjustment device may vary the slope of such linear graph defining the braking force/braking torque over displacement and/or may vary the shape of a graph defining the braking force/braking torque verses displacement of the working head and/or working head element, for example from a linear shape to a non-linear shape. In addition or in the alternative, the adjustment device may vary the ratio of linear portions to non-linear portions.

For example, to allow variation of the braking force and/or braking torque, a mechanical brake such as a disc brake may be connected to the working head and/or the working head element, wherein such braking device may provide for dry friction. To vary the braking force and/or braking torque, an actuator may be provided for varying the contact pressure of the cooperating movable and non-movable braking elements.

According to a still further aspect, at least one adjustment actuator may be provided for varying the shape of a graph defining the restoring force and/or restoring torque of a restoring device over rotatory and/or linear displacement of the working head and/or working head element from a linear shape to a curved shape and/or the ratio of linear portions to non-linear portions of said graph.

More particularly, the restoring device for urging the working head and/or the working head element towards a desired neutral position may include at least one leaf spring connected to the working head and/or the working head element, wherein the adjustment actuator may be configured to change the effective length of such leaf or leg spring.

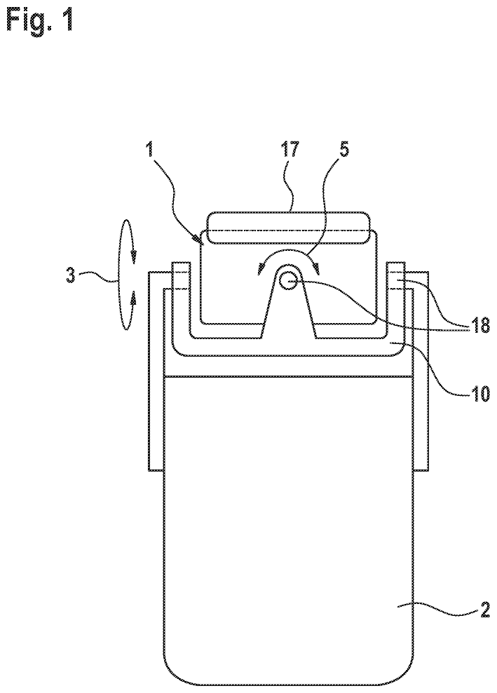

As can be seen from FIG. 1, the personal care device 20 includes an elongated handle 2 to be gripped by the fingers of a user to move the personal care device 20 along a body surface to be treated. Said handle 2 may form a housing in which functional and/or structural parts of the personal care device 20 may be accommodated, for example an energy storage such as a battery, a drive motor and/or a control unit for controlling the function such as a microprocessor with a program storage connected thereto. Alternatively or in addition the device may communicate wireless via e.g. Bluetooth with a smart device like a smartphone and may employ the processor and storage of that smart device for supporting in those processing tasks and visualizing the result at the display.

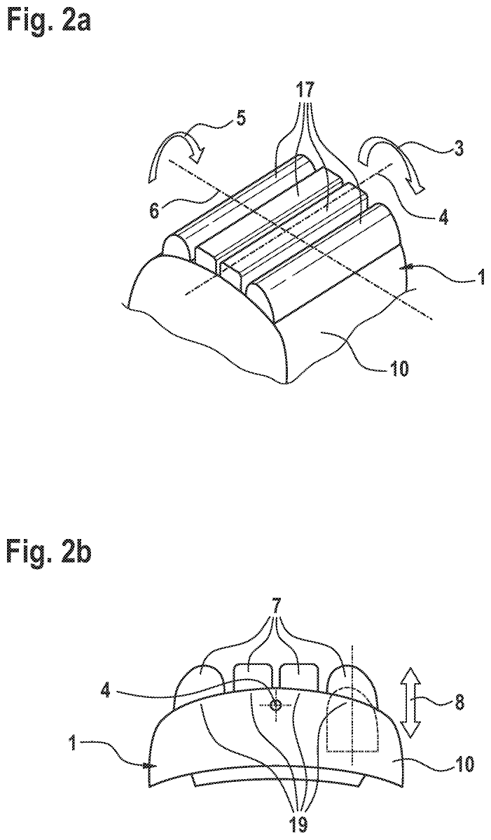

A working head 1 supported on said handle 2 includes one or more working head elements 7 for performing the care treatment. In case of a shaver which is illustrated in the figures, said working head element 7 may include hair cutting elements such as shear foil cartridges and/or a rake-like trimmer, cf. FIG. 2.

The working head element 7 may define a skin contact surface 17 of the working head 1, wherein said skin contact surface 17 may extend substantially perpendicular to a longitudinal axis of the handle 2 or inclined thereto, depending on the rotatory position of the working head 1. For example, the skin contact surface 17 may be formed by a distal end side of the working head 1.

As illustrated by FIGS. 1 and 2a-2b, the working head 1 may be supported on the handle 2, by means of a suspension 18, in a movable manner so that the working head 1 may be rotated and/or linearly displaced relative to the handle 2. For example, the suspension 18 may allow for swiveling 3 of the working head 1 about a swivel axis 4, cf. FIG. 2a-2b, and/or tilting 5 of the working head 1 about a tilt axis 6. Said swivel and tilt axes 4 and 6 may extend substantially perpendicular to each other and/or substantially parallel to the aforementioned skin contact surface 17, cf. FIG. 2a-2b.

In addition or in the alternative to such rotatory movability, the working head 1 also may be linearly displaced relative to the handle 2, for example along a displacement axis substantially parallel to the longitudinal axis of the handle 2 so that the working head 1, as a whole, may dive or float when the skin contact surface 17 is pressed against the body surface.

In addition or in the alternative to the movability of the working head 1 as a whole, one or more working head elements 7 such as the aforementioned shear foil cartridges, may be movably supported relative to a working head basis 10 by means of a suspension 19. The working head basis 10 may form a frame-like structure which may swivel and/or tilt relative to the handle 2 in the aforementioned manner so that the additional movability of the working head element 7 may be superposed to the movability of the working head basis 10.

For example, the working head elements 7 may be linearly displaced along a displacement axis 8 which may extend substantially perpendicular to the skin contact surface 17 so that the working head element 7 may dive or float when subject to skin contact pressure. In addition or in the alternative to such linear diving, the suspension 19 of the working head element 7 also may allow for rotatory movements of the working head elements 7 relative to the working head basis 10 to allow for adaption of the working head element 7 to the skin contour. In particular, the working head element 7 may tilt around a tilt axis parallel to tilt axis 6 of working head 1.

The adaptive movements of the working head 1 and/or the working head element 7 to the skin contour may be controlled by an adaption controller 24 which may include one or more mechanisms and/or actuators and/or mechanical controllers to influence one or more of the aforementioned movements. Such actuator may be motor or electric driven as described herein or manually operated by the user.

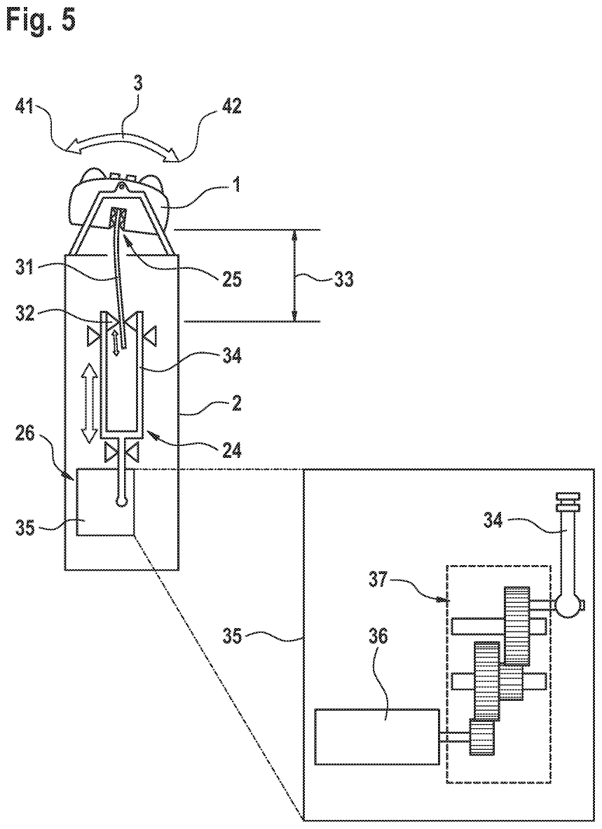

For example, as shown by FIG. 5, the adaption controller 24 may include a restoring device 25 applying a restoring force and/or torque onto the working head 1 to urge the working head 1 towards a neutral or starting position which may be an intermediate position from which the working head 1 may move into opposite directions. For example, the restoring device 25 may be configured to urge the working head 1 into a neutral swivel position about swivel axis 4.

Said restoring device 25 may include a leaf spring 31 connected or rigidly fixed to the working head basis 10 in a way such that swivel 3 of the working head 1 causes the leaf spring 31 to pivot and thus, bend. As can be seen from FIG. 5, leaf spring 31 is also connected to the handle 2 or a structural element fixed to said handle 2, by means of a spring bearing 32 which limits rotatory movements of the leaf spring 31 due to swiveling of the working head 1.

So as to adjust the restoring force and/or restoring torque of the leaf spring 31, the effective length 33 of the leaf spring 31 may be adjusted, wherein, for example, the aforementioned spring bearing 32 may be displaced in a direction substantially parallel to the longitudinal axis of the leaf spring 31. For example, the spring bearing 32 may be displaced in a direction parallel to the longitudinal axis of the handle 2, cf. FIG. 5, to change the effective length 33 of leaf spring 31.

Displacement of the spring bearing 32 may be effected by means of an actuator 35 which can be controlled by the aforementioned control unit. For example, said actuator 35 may include a motor 36 such as an electric motor which is connected to the displaceable spring bearing 32 via a drive train or connector or transmitter 34 transmitting the drive movement of the motor 36 to the spring bearing 32.

For example, a gearing 37 may be provided between a drive shaft of motor 36 and transmitter 34 so as to transform, for example, a rotatory drive shaft movement into a substantially linear displacement of the spring bearing 32.

The restoring device 35 may be configured such that the aforementioned leaf spring 31 is undeflected and/or straight when the working head 1 is in its neutral position. Thus, no torque and/or restoring force is applied to working head 1 when the latter is in its neutral position. In other words, when starting displacement of the working head 1 out of its neutral position, substantially no torque and/or force is necessary so swiveling 3 may start at substantially zero resistance at the neutral position.

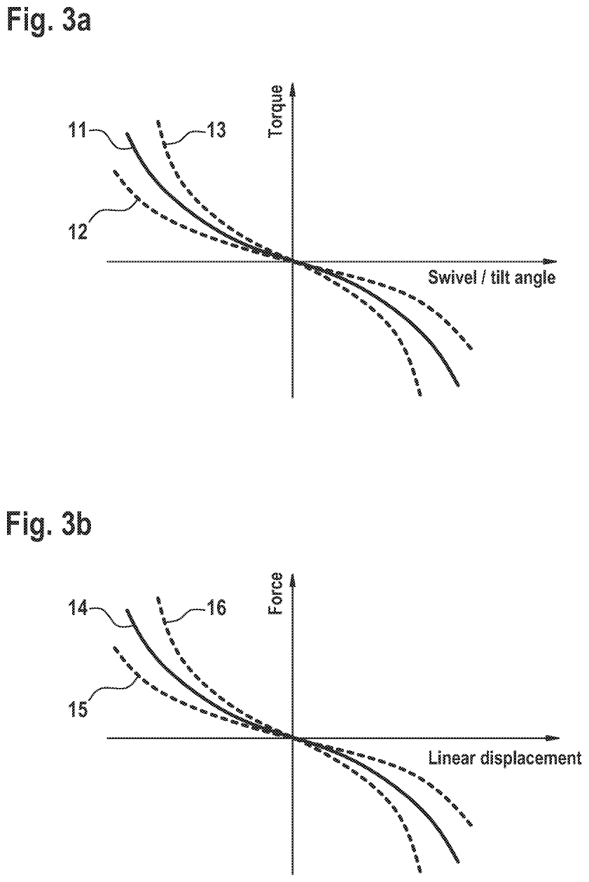

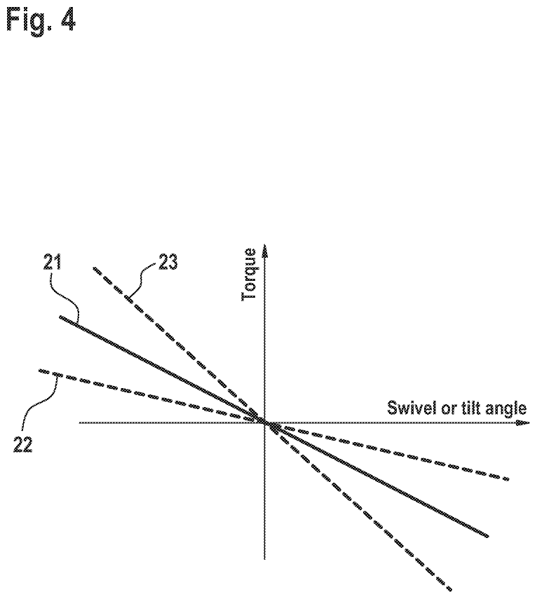

Depending on the configuration of the restoring device 25, different restoring characteristics may be provided, as can be seen from FIGS. 3a-3b and 4.

Partial view a of FIG. 3 shows a torque characteristic wherein the swiveling and/or tilting torque increases with increasing swivel and/or tilt angles in a non-linear way. Despite this exemplary illustration of FIG. 3a in nonlinear way it is to be understood that all functional relationships are comprised. The larger the swivel or tilt angle gets, the steeper the torque increase becomes. Curve 11 represents a medium rotation stiffness, whereas curve 12 represents a reduced rotation stiffness and curve 13 represents an increased rotation stiffness. Such variation of the rotation stiffness may be achieved, for example, by adjusting the effective length 33 of leaf spring 31 of restoring device 25, cf. FIG. 5. When the effective length 33 is reduced, the rotation stiffness increases, whereas increasing the effective length 33 leads to a reduced rotation stiffness.

As can be seen from FIG. 4, the torque characteristic may be e.g. a linear one, wherein the resistive and/or restoring torque may linearly increase with an increasing swivel or tilt angle. Again, swivel or tilt stiffness may be adjusted also in case of a linear characteristic, wherein line 21 represents a medium swivel or tilt stiffness, whereas line 22 represents a reduced rotatory stiffness and line 23 represents an increased rotatory stiffness.

Adjustment of such linear torque characteristics also may be achieved by means of the restoring device 25 and the adjustment device 26 associated therewith. When the effective length is reduced, increased stiffness can be achieved, whereas reduced stiffness can be achieved by increasing the effective length 33.

It should be mentioned that both the non-linear characteristics shown by FIG. 3a and the linear characteristic shown by FIG. 4 can be achieved by means of the restoring device 25 and the adjustment device 26 associated therewith as shown by FIG. 5. To achieve one of the linear characteristics of FIG. 4, the spring bearing 32 is adjusted to a fixed position so that the effective length 33 is set to a fixed value held constant irrespective of the swivel or tilt angle of working head 1.

On the other hand, to achieve the non-linear characteristic of FIG. 3a, the effective length 33 may be adjusted in dependency of the tilt or swivel angle. More particularly, when the swivel or tilt angle increases, the effective length 33 may be reduced continuously or step by step so that the graph defining the functional relationship between torque and swivel/tilt angle becomes steeper and steeper when the swivel/tilt angle gets larger, as shown by FIG. 3a. It should be understood, nevertheless, that various non-linear characteristics may be achieved by means of reducing and/or increasing the effective length 33 in other ways depending on the tilt or swivel angle. For example, a hybrid characteristic including a linear graph portion and a non-linear graph portion may be achieved by setting the effective length 33 to a fixed value for a certain range of swivel and/or tilt angles, and, on the other hand, varying the effective length 33 continuously or step by step for another range of swivel and/or tilt angles.

As shown by FIG. 3b, also for linear displacements of the working head 1 and/or the working head element 7, such as the diving movements 8 as shown by FIG. 2b, different force characteristics may be provided. For example, a restoring device including a leaf spring similar as the restoring device 25 may be employed, wherein for example the leaf spring, with its longitudinal axis, may be arranged transverse to the diving axis 8 to be deflected when the working head element dives. Again, adjusting diving stiffness may be achieved by increasing and/or decreasing the effective length of such leaf spring. In addition or in the alternative, other restoring devices including other types of springs such as a compression spring may be used to influence the diving characteristics, wherein for example the spring bearing may be displaced along the axis of compression.

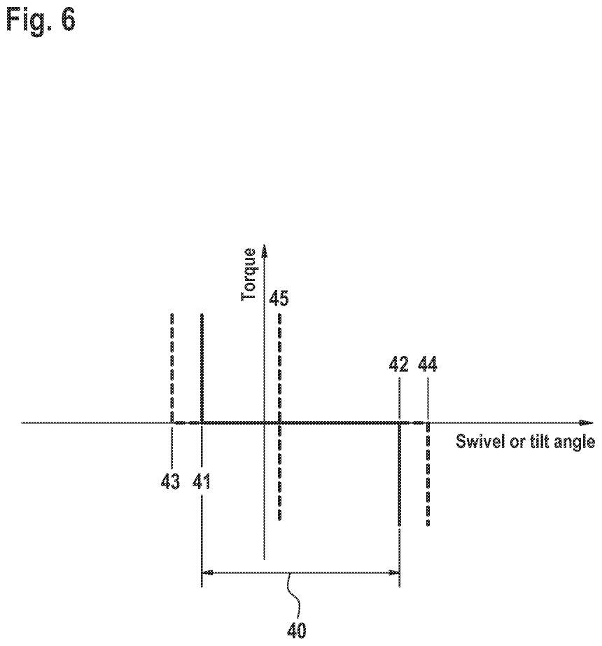

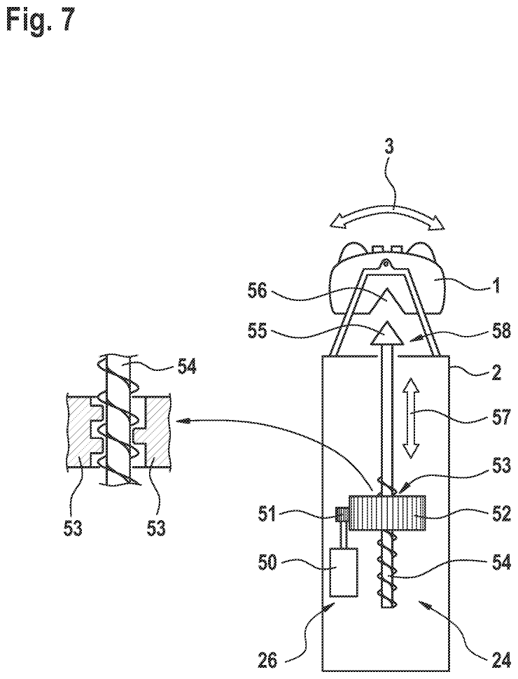

As shown by FIGS. 6 and 7, the force and/or torque characteristic in dependency of the rotatory or linear displacement of the working head 1 and/or of the working head element 7, in particular in dependency of the swivel or tilt angle of working head 1, also may be controlled by a displacement range limiter 58 which may limit the available maximum rotatory and/or linear displacement.

For example, as shown by FIG. 7, the displacement range limiter 58 may limit the maximum swiveling 3 of working head 1.

In this embodiment, an actuator 50 . . . 54 is used to push a wedge 55 into a gap 56 at the bottom of the shaving head 1. Depending on the extend how far the actuator moves the wedge into the gap along the direction 57, the swivel range is more or less limited. In the lower position of the wedge 55, the swivel rotation has a wide range. With upward moving wedge, the range becomes smaller until the swivel rotation is completely blocked when the wedge is moved to its upper mechanical limit. The head is then forced into a predefined position. In detail, the actuator works in this way: a motor 50 turns a gear 51, which drives a second gear 52. This gear 52 contains an internal thread 53 and is placed on a threaded rod 54. The threaded rod is moved up and down, as soon as the motor 50 turns. In summary, the minimum- 41 and maximum- 42 angles of the head swiveling can be adjusted with the help of the motor 50.

As can be seen from FIG. 6, there is a relation between the swivel or tilt angle of the shavers head and the torque that the head builds up at this angle. Here, it leads to the modification of the swivel range 40, FIG. 6. The minimum and maximum angle that is possible for swiveling or tilting are modified in this case. An undisturbed movement is possible up to these defined minimum- 41 and maximum- 42 angles and any movement to angles outside this range is blocked. The torque, built up against any further rotation is higher than any torque value that has to be expected during shaving. A change in the adjustment leads to different values for the angles 41 and 42, e.g. 43 as a new minimum- and 44 as a new maximum angle. Also the case of identical values for the minimum- and maximum- angle is included in this concept. Any tilting or swiveling is completely blocked in that case and the head is forced into a predefined position, indicated with 45. As an option, there can also be several predefined positions. In this case, the head is forced into one of these predefined positions, e.g. into the nearest one. A property of the curves to be remarked is the fact, that the absolute value of the torque never decreases with increasing absolute value of the angle. A note has to be made about the region of zero torque in the curves of FIG. 6. The value 0 is an ideal case which does not include the unavoidable influence of friction. This may add a typical value of 0.3 Nmm of torque or another torque value of similar amounts.

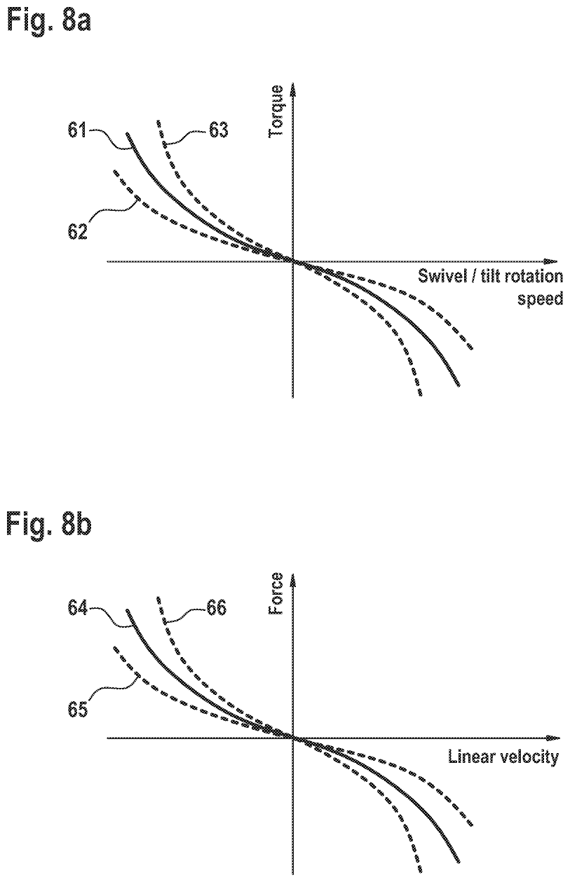

According to another aspect, the torque and/or force characteristic also may be configured to be dependent on rotatory and/or linear speed of the adaption movement of the working head 1 and/or the working head element 7, as it is shown by FIGS. 8, 9, 11 and 13, wherein the adjustment device may include one or more adjustment actuators 85 changing the torque and/or force characteristics depending on rotatory and/or linear speed.

To control torque and/or force for moving the working head 1 and/or the working head element 7 in a rotatory and/or linear way, in dependency of rotatory and/or linear speed of said working head 1 and/or working head element 7, at least one actuator may be provided for adjusting moving resistance depending on moving speed. Such adjustment actuator may include a friction device and/or braking device and/or dampening device to apply a friction and/or braking and/or dampening force and/or torque to the working head 1 and/or the working head element 7 to control contour adaption thereof.

FIG. 8 shows similar curves like FIG. 3, but this time as a function of the rotation speed in FIG. 8a and as a function of the linear velocity in FIG. 8b.

Another concept focuses on a relation 61, in FIG. 8a, between the rotation velocity applied to the head and a torque that the device builds up against it. In contrast to the previous embodiments, the torque does not depend on the angle, but on the change of the angle in time i.e. the rotation speed. This relation 61 is the characteristics that is modified in this concept.

FIG. 8a is a very general illustration of such a characteristics and the way how it can be modified, resulting e.g. in the characteristic 62 or 63.

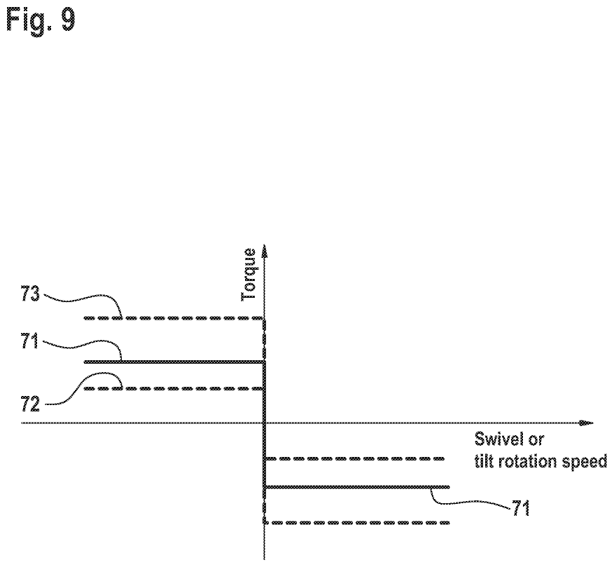

FIG. 9 shows a more specific case that can well be achieved with the type of friction that is called dry friction: There is a braking torque that is directed against the movement. It is directed against the rotation velocity, but does not depend on the absolute value of the rotation velocity. Weaker and stronger braking torque-values are possible, resulting in a change of the characteristics from the curve 71 to e.g. the curve 72 or 73.

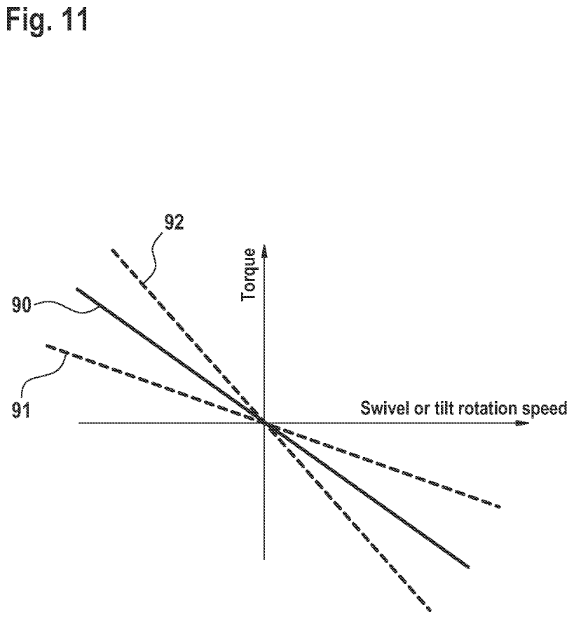

FIG. 11 shows the case with the characteristics 90, being typical for the type of friction that is called viscose friction: There is a braking torque that is directed against the movement. In contrast to the previous embodiment, its absolute value increases with the rotation velocity. Furthermore, a modification of the characteristics is possible and the increase of the braking torque with the velocity can be controlled, resulting e.g. in the curves 91 and 92.

To adjust the torque and/or force in dependency of speed in the aforementioned ways and also to switch from one type of characteristic to another type of characteristic, the adjustment device 85 may include one or more actuators to adjust a friction force/torque and/or braking force/torque and/or dampening force/torque, wherein the one or more adjustment actuators may be controlled in response to rotatory and/or linear speed of the working head 1 and/or the working head element 7.

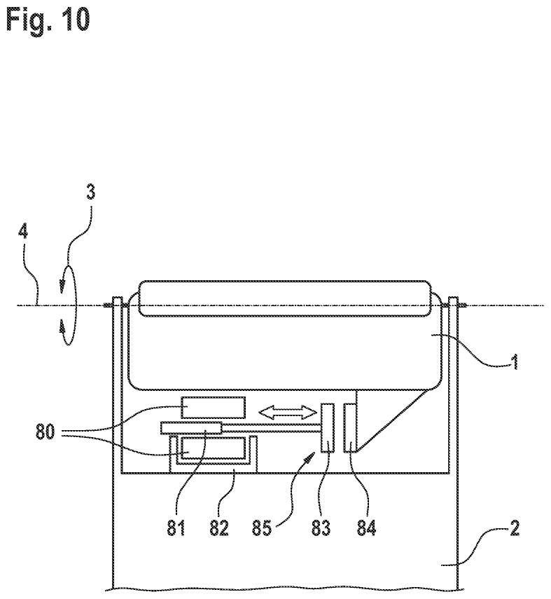

For example, as shown by FIG. 10, a brake device 85, in particular a dry brake device may be provided to brake contour adaption movements of the working head 1 and/or the working head element 7. For example, such brake device 85 may include a disc brake unit. More particularly, an actuator 80..82 pushes a brake pad 83 against a surface 84 that moves with the swiveling shaving head. This surface 84 has the function of the disc in a disc brake. Depending on the force, applied by the actuator 80 . . . 82, more or less torque is needed to swivel the head 1. Full blocking of the head is possible with sufficiently high force from the actuator. As soon as the actuator releases the brake pad 83, the swivel movement 3 is free again. In detail, the actuator works in the following way: A coil 80 generates a magnetic field. This field leads to a force that pulls the iron core 81 into the middle of the coil 80. The magnetic field is closed via the iron counter plate 82. The iron core 81 pushes the brake pad 83 against the surface 84 depending on the current through the coil 80. In summary, the current through the coil 80 defines the torque, needed to swivel the head 1.

It should be understood that different braking torque/force characteristics may be achieved by means of such brake device 85. For example, the constant type characteristic of FIG. 9 may be achieved by means of setting the actuator 80, 81 and 82 to apply a constant force onto the brake pad 83 against brake disc 84, wherein different levels of braking torque/force according to lines 71, 72 and 73 may be adjusted when increasing or decreasing the contact pressure.

On the other hand, also non-linear characteristics are shown by FIG. 8 or a linear characteristic is shown by FIG. 11 may achieved by means of brake device 85 when the braking force created by actuator 80 to 82 is controlled and/or varied in response to rotatory and/or linear speed of the contour adaption movements of the working head 1 and/or the working head element 7. For example, to achieve a linear characteristic as shown by FIG. 11, the braking device 85 may start with a braking force of substantially zero when swivel or tilt speed is substantially zero. When such swivel and/or tilt speed increases, also the braking force may be adjusted to increase, in particular in accordance with a linear relationship to swivel/tilt speed.

On the other hand, to achieve a non-linear characteristic as shown by FIG. 8, the braking force created by the actuator 80 to 82 may be controlled in a non-linear way depending on rotatory speed and/or linear velocity.

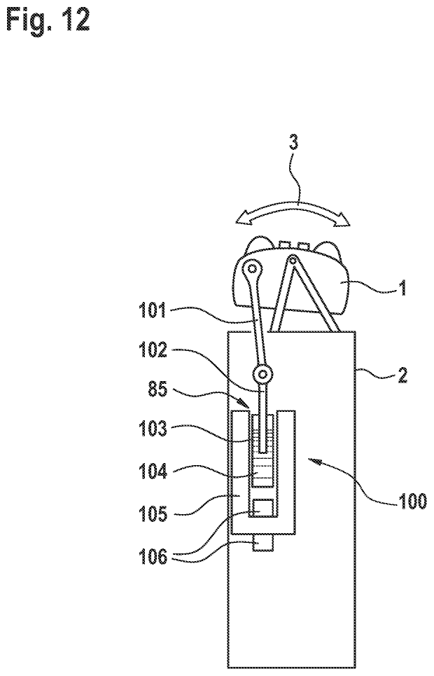

Another example to control torque and/or force in dependency of speed, is shown by FIG. 12 which shows a viscose type of friction device similar to a damper.

More particularly, such viscose type of friction device 100 may include a fluid pusher for pushing a viscose fluid away or move through that viscous fluid when the working head 1 and/or working head element 7 moves to adapt to the body surface contour. To adjust the resistance of the fluid pusher in dependency of speed, a smart viscose fluid may be used which is configured to change its viscosity when subject to a magnetic field and/or subject to an electric field.

More particularly, as shown by FIG. 12, a connecting rod 101 moves the element 102 up and down synchronously with the swivel rotation of the head. This element 102 acts as an inner damper element. This inner damper element is located inside the outer damping element 103. The space between inner and outer damping is filled with a magnetic liquid 104. The magnetic liquid is located between the poles of an electromagnet consisting of an iron core 105 and one or more coils 106. The viscosity of the magnetic liquid 104 is modified with the help of an electrical current through the coil(s) 106. Depending on the current, the coil(s) generate a magnetic field in the volume of the magnetic liquid 104. The higher the magnetic field, the higher is the viscosity of the magnetic liquid. The curve 90 in FIG. 11 is then turned further away from its first orientation, e.g. to the curve 92. A higher level of damping is then perceived by the user when the head is swiveled. If the current through the coil 106 is lowered, the characteristics is modified towards the curve 91. In summary, the current through the coil 106 controls the torque, needed to swivel the head 1 with a specific rotation speed.

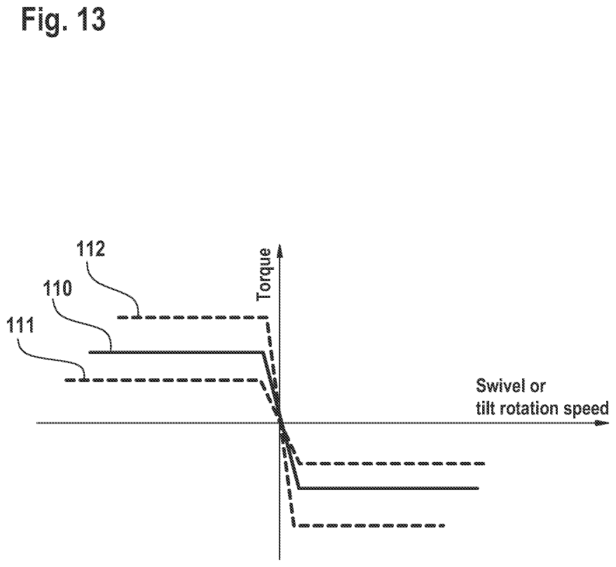

There are also solutions possible that are a combination of the 4 described ones. As an example, a combination of the options in FIGS. 5 and 7 can limit the range while also increasing the stiffness. The characteristics indicated in FIG. 13 are example curves of characteristics that can be achieved in such a case.

As shown by FIG. 13, hybrid torque/force characteristics may be achieved by controlling the aforementioned adjustment actuators, wherein two or more of the aforementioned adjustment actuators may be combined with each other.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. Personal care device, in particular hair removal device such as an electric shaver, comprising an elongated handle for manually moving the personal care device along a body surface, a working head attached to said handle for effecting a personal care treatment to said body surface, said working head being movably supported relative to said handle and/or including a working head element being movably supported relative to a working head basis to allow adaption of the working head and/or of the working head element to the body surface contour, wherein an adjustment device is provided for adjusting a movability characteristics of a suspension of said working head and/or of said working head element, characterized in that said adjustment device includes at least one actuator for adjusting at least one of the following characteristics:
moving resistance of the working head and/or of the working head element depending on moving speed of the working head and/or the working head element, each relative to the handle,
restoring force/torque urging the working head and/or the working head element towards a neutral position depending on moving speed of the working head and/or of the working head element,
braking force/torque for braking movements of the working head and/or of the working head element into each of opposite directions,
the shape of a graph defining a restoring force/restoring torque over rotatory and/or linear displacement of the working head and/or the working head element from a linear graph to a curved graph and/or the ratio of linear portions to non-linear portions of said graph.

2. Personal care device according to claim 1, wherein the at least one adjustment actuator for adjusting moving resistance depending on moving speed is configured to change the shape of a graph defining moving resistance over moving speed in terms of changing curvature of said graph and/or changing the ratio of curved graph portions to linear graph portions and/or changing the slope of and/or a point of inflection of said graph.

3. Personal care device according to claim 1, wherein said adjustment actuator is configured to provide for a moving resistance of zero when moving speed is zero and to provide for an amount of a moving resistance larger than zero when the working head and/or the working head element is moving, wherein a direction of moving resistance force/torque for negative moving speeds is opposite to a direction of moving resistance force/torque for positive moving speeds.

4. Personal care device according to claim 1, wherein said adjustment actuator is configured to adjust the braking force of a braking device and/or is controlled in response to a speed signal of a speed detector for detecting moving speed of contour adaption movements of the working head and/or the working head element.

5. Personal care device according to claim 1, wherein said brake device is a dry brake and/or includes a brake disc.

6. Personal care device according to claim 1, wherein said adjustment actuator includes a fluid pusher connected to the working head and/or the working head element for pushing away a viscose fluid when the working head and/or the working head element is moving.

7. Personal care device according to claim 1, wherein said viscose fluid is a smart viscose fluid changing its viscosity depending on an electric or magnetic field applied thereto, wherein the adjustment device includes a controller for changing said electric or magnetic field.

8. Personal care device according to claim 1, wherein said adjustment device is configured to change viscosity of the viscose fluid and/or moving resistance of said fluid pusher in response to moving speed of said working head of said working head element.

9. Personal care device according to claim 1, wherein said adjustment actuator for adjusting the restoring force/torque and/or the shape of the graph defining restoring force/torque over rotatory and/or linear displacement of the working head and/or the working head element is configured to adjust the restoring force/torque of a restoring device.

10. Personal care device according to claim 1, wherein said restoring device includes a leaf spring connected to the working head and/or the working head element in a way to be deflected by contour adaption movements of the working head and/or the working head element, wherein the adjustment actuator is configured to adjust an effective length of said leaf spring by means of displacing a spring bearing.

11. Personal care device according to claim 1, wherein said adjustment actuator is controlled by a controller in response to a speed signal of a speed detector for detecting moving speed of contour adaption movements of said working head and/or said working head element.

12. Personal care device according to claim 1, wherein said adjustment device includes a displacement range limiter for limiting a maximum available rotatory and/or linear displacement of said working head and/or said working head element, wherein said displacement range limiter is adjustable by an adjustment actuator to change the available displacement range.

13. Personal care device according to claim 1, wherein said range limiter includes a pair of engagement elements, one of which is wedge-shaped and one of which is roof-shaped, wherein at least one of said engagement elements is movably supported to be moved towards and away from the other engagement element such that wedge-shaped contour may enter into the roof-shaped contour, wherein the adjustment actuator is configured to hold the engagement elements at varying distances from each other defining varying displacement ranges.
